(19) United States
(12) Patent Application Publication
(10) Pub. No.: US 2017/0325295 A1
(43) Pub. Date: Nov. 9, 2017

(54) HEAT-COOKING APPARATUS

(71) Applicant: Panasonic Intellectual Property Management co., Ltd., Osaka (JP)

(72) Inventors: Masaki SHIBUYA, Osaka (JP); Akira KATAOKA, Shiga (JP)

(21) Appl. No.: 15/525,762

(22) PCT Filed: Nov. 2, 2015
(86) PCT No.: PCT/JP2015/005493

§ 371 Date: May 10, 2017

(30) Foreign Application Priority Data
Nov. 18, 2014 (JP) 2014-233247

(51) Int. Cl. H05B 6/64; F24C 7/02; F24C 1/08; A47J 27/04; F24C 15/16

(52) U.S. Cl. CPC H05B 6/6479; F24C 1/08; A47J 27/04; F24C 7/02; A47J 2027/043; F24C 15/16

(57) ABSTRACT

A heat-cooking apparatus according to the present invention includes a heating chamber for heating a food product, a steam generator for generating steam, and a steam channel provided in the heating chamber for guiding steam generated by the steam generator. The heat-cooking apparatus further includes a loading table for disposing a heat-target object, which is raised from a bottom surface of the heating chamber to create a predetermined gap, and a loading table opening portion provided on the loading table for guiding steam from the steam channel to the heat-target object. Steam generated by the steam generator passes through the steam channel and the loading table opening portion to heat the heat-target object. Therefore, without requiring a steamer, steam cooking can easily be performed.

### TECHNICAL FIELD

The present invention relates to a heat-cooking apparatus.

### BACKGROUND ART

For a conventional heat-cooking apparatus for use in steam cooking, a steamer provided in a heating chamber has been proposed. In this kind of a heat-cooking apparatus, a steam generating nozzle and a steam inlet of a steamer are provided separately, and steam is injected from the steam generating nozzle to the steam inlet to fill the steam in the steamer for steam cooking (for example, see PTL 1).

However, if the steamer is left installed in the heating chamber, the steamer hinders heating of a heat-target object using heating means other than using steam supplied by the steamer (for example, microwaves). In this case, each time heating is to be performed, a user has to remove the steamer from the heating chamber before disposing a heat-target portion in the heating chamber. A place to put the removed steamer is also required. Another problematic effort is to open a cover of the steamer to dispose a heat-target object in the steamer.

On the other hand, in steam heating where steam is ejected in the heating chamber without using the steamer, the steam disperses inside the even wider heating chamber. Therefore, heating efficiency deteriorates, and thus a heating time becomes longer.

Due to the wider heating chamber, a portion closer to the steam ejection port would be excessively heated, while other portions would not be fully heated, which could lead to greater unevenness in heating.

Still another problem is that cleaning of the whole internal walls of the heating chamber is required after heating, since the internal walls of the heating chamber are contaminated with dew condensation water, as well as moisture and oil components generated from heat-target objects.

### CITATION LIST

### Patent Literature

PTL 1: Unexamined Japanese Patent Publication No. 2007-271104

### SUMMARY OF THE INVENTION

In view of the above problems in the conventional art, the present invention has an object to provide a heat-cooking apparatus capable of easily perform steam cooking without using a steamer, as well as capable of increasing steam heating efficiency, reducing a heating time, and improving ease of cleaning.

To solve the above described problems in the conventional art, the heat-cooking apparatus according to the present invention includes a heating chamber for heating a food product, a steam generator for generating steam, and a steam channel provided in the heating chamber for guiding steam generated by the steam generator. The heat-cooking apparatus further includes a loading table for disposing a heat-target object, the loading table is raised from a bottom surface of the heating chamber to create a predetermined gap, and a loading table opening portion provided on the loading table for guiding steam from the steam channel to the heat-target object. Steam generated by the steam generator passes through the steam channel and the loading table opening portion to heat the heat-target object.

Therefore, by simply disposing a heat-target object on the loading table opening portion, and performing steam heating, steam cooking can easily be performed without using a steamer. Since steam is guided by the steam channel to the loading table opening portion without being dispersed in the heating chamber, and is directly ejected around the heat-target object, the heat-target object can effectively be heated. Therefore, unevenness in heating around the ejection port and dew condensation on the internal walls of the heating chamber can be suppressed in minimum. Since moisture, oil components, and the like generated from the heat-target object drop onto the steam channel, by simply cleaning the steam channel only, the heating chamber can be kept clean.

The heat-cooking apparatus according to the present invention is capable of easily performing steam cooking without using a steamer, as well as capable of increasing steam heating efficiency, reducing a heating time, and improving ease of cleaning.

### BRIEF DESCRIPTION OF THE DRAWINGS

FIG. 1 is a perspective view of a heat-cooking apparatus according to a first exemplary embodiment of the present invention.

FIG. 2 is a front cross-sectional view of the heat-cooking apparatus according to the first exemplary embodiment of the present invention.

FIG. 3 is a front cross-sectional view of an essential portion of a loading table of the heat-cooking apparatus according to the first exemplary embodiment of the present invention.

FIG. 4 is a top view of the loading table of the heat-cooking apparatus according to the first exemplary embodiment of the present invention, where no food product is disposed.

FIG. 5 is a schematic view illustrating how steam flows in a steam channel of the heat-cooking apparatus according to the first exemplary embodiment of the present invention.

FIG. 6 is a front cross-sectional view of an essential portion of a loading table of a heat-cooking apparatus according to a second exemplary embodiment of the present invention.

FIG. 7 is a top view of a food container of the heat-cooking apparatus according to the second exemplary embodiment of the present invention, where a cover is removed.

### DETAILED DESCRIPTION OF THE PREFERRED EMBODIMENTS

A heat-cooking apparatus according to a first aspect of the present invention includes a heating chamber for heating a food product, a steam generator for generating steam, and a steam channel provided in the heating chamber for guiding steam generated by the steam generator. The heat-cooking apparatus further includes a loading table for disposing a heat-target object, which is raised from a bottom surface of the heating chamber to create a predetermined gap, and a loading table opening portion provided on the loading table for guiding steam from the steam channel to the heat-target object. Steam generated by the steam generator passes through the steam channel and the loading table opening portion to heat the heat-target object.

Therefore, by simply disposing a heat-target object on the loading table opening portion, and performing steam heating, steam cooking can easily be performed without using a steamer.

Since steam is guided by the steam channel to the loading table opening portion without being dispersed in the heating chamber, and is directly ejected around the heat-target object, the heat-target object can effectively be heated. Therefore, unevenness in heating around the ejection port and dew condensation on the internal walls of the heating chamber can be suppressed to the minimum.

Further, since moisture, oil components and the like, generated from the heat-target object drop onto the steam channel, the heating chamber can be kept clean so that simply cleaning of the steam channel only needs to be performed.

A second aspect of the present invention is particularly directed to the heat-cooking apparatus according to the first aspect of the present invention, a top surface of a loading table is formed in a plane. A term “plane” used herein includes approximately plane.

Therefore, even a flat, larger heat-target object can easily be disposed and heated on the loading table, without leaving the heat-target object inclined.

A third aspect of the present invention is particularly directed to the heat-cooking apparatus according to the first or second aspect of the present invention, a loading table and an opening plate having a loading table opening portion are provided separately, and the opening plate is detachably provided to the loading table.

Therefore, by removing the opening plate only from the loading table, moisture, oil components, and the like generated from heat-target objects and adhered onto the opening plate can easily be cleaned. Further, by removing the opening plate, the steam channel that has been contaminated as described above can easily be cleaned.

A fourth aspect of the present invention is particularly directed to the heat-cooking apparatus according to any one of the first to third aspects of the present invention, a loading table is detachably provided to the heating chamber.

Therefore, by removing the loading table from the heating chamber, moisture, oil components, and the like generated from heat-target objects and adhered onto the loading table can easily be cleaned. Since, by removing the loading table, an area occupied by the loading table becomes available, a further taller heat-target object can be disposed and heated in the heating chamber.

A fifth aspect of the present invention is particularly directed to the heat-cooking apparatus according to any one of the first to fourth aspects of the present invention, a steam generator includes a steam ejection port for ejecting generated steam, and the steam ejection port is detachable from the steam channel each other.

Therefore, by removing the steam channel from the steam ejection port, moisture, oil components, and the like generated from heat-target objects and adhered onto the steam channel can easily be cleaned.

A sixth aspect of the present invention is particularly directed to the heat-cooking apparatus according to any one of the first to fifth aspects of the present invention, the heat-cooking apparatus includes a steam channel control plate for altering a steam channel direction in the steam channel.

Therefore, steam can evenly fill in the steam channel to reduce unevenness in heating of a food product.

A seventh aspect of the present invention is particularly directed to the heat-cooking apparatus according to any one of the first to sixth aspects of the present invention, the heat-cooking apparatus further includes, on the loading table, a food container for accommodating a heat-target object, and the food container has a bottom surface provided with a food container hole that is in communication with the loading table opening portion.

Therefore, steam can fill, without being dispersed in the heating chamber, in a narrower space of the food container to further effectively heat a food product. Therefore, a heating time can be reduced, and the food product can be well cooked in an improved manner.

Since most of moisture, oil components, and the like generated from a food product can be stored in the food container, the contamination of the heating chamber, the loading table, the opening plate, and the steam channel can be suppressed, thus improving easy cleaning. Further, since a user does not have to directly touch a food product, the user is free from burns, and is able to handle the food product in a sanitary manner.

An eighth aspect of the present invention is particularly directed to the heat-cooking apparatus according to the seventh aspect of the present invention, a food container includes a cover provided with a steam hole.

Therefore, steam can flow into the food container, and a food product can be well steam-heated in an improved manner.

A ninth aspect of the present invention is particularly directed to the heat-cooking apparatus according to any one of the first to eighth aspects of the present invention, the heat-cooking apparatus further includes a microwave generator for generating microwaves to heat the heat-target object.

Therefore, when steam heating and microwave heating are simultaneously performed, through defrosting of a surface of a heat-target object with steam, a rate of absorption of microwaves can be increased, and the heat-target object can effectively be heated. In particular, this method is effective when a heat-target object is a frozen food product with a lower rate of absorption of microwaves.

Exemplary embodiments of the present invention will be described below with reference to the drawings. However, the present invention is not restricted by the exemplary embodiments.

### FIRST EXEMPLARY EMBODIMENT

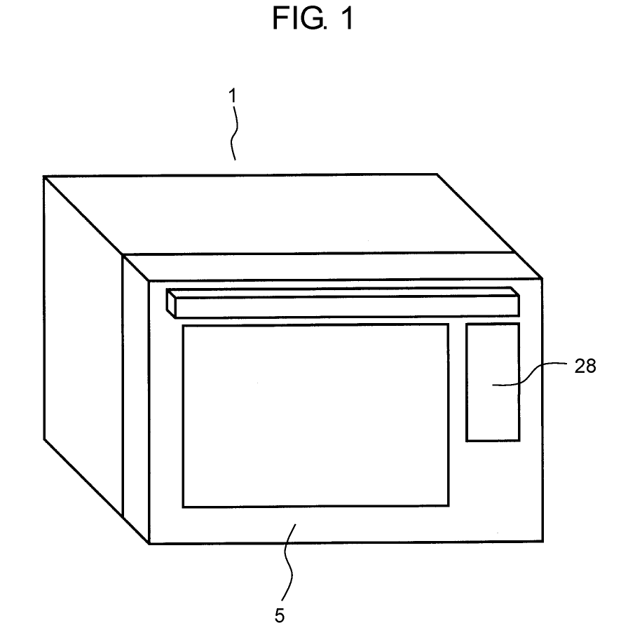

FIG. 1 is a perspective view of a heat-cooking apparatus according to a first exemplary embodiment of the present invention.

In FIG. 1, inside a body of high frequency heat-cooking apparatus 1 (heat-cooking apparatus), heating chamber 2 described later is provided. On a front face of heating chamber 2, an opening portion is provided. On this opening portion, door 5 is openably provided. When a user turns and opens this door 5 toward him or her, through the opening portion, the user can put a food product in heating chamber 2 and take out the food product from heating chamber 2.

In this exemplary embodiment, respective directions referred in the below descriptions are as follows: an opening side of heating chamber 2 as front, a right side when viewed from the front to rear as right, and a left side when viewed from the front to a body as left.

Door 5 is provided openably in a top-bottom direction. On a front face of this door 5, operation display 28 is provided, through which the user is able to set a cooking menu or a cooking time. A safety switch (not shown) is provided to the body of high frequency heat-cooking apparatus 1 for stopping, when door 5 is open, operations of heat sources of high frequency heat-cooking apparatus 1.

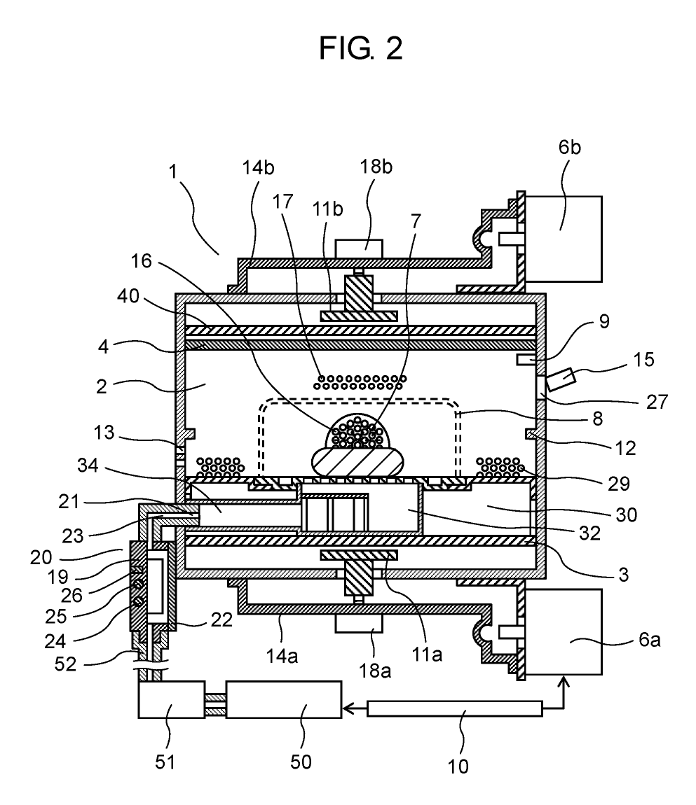

FIG. 2 is a front cross-sectional view of the heat-cooking apparatus including a loading table, according to the first exemplary embodiment of the present invention.

In FIG. 2, in heating chamber 2, a surface of an aluminum plated steel sheet is fluorine-coated. At a lower portion in heating chamber 2, tray table 3 made of crystallized glass is fixed and attached to heating chamber 2. Under a ceiling surface of heating chamber 2, top plate 40 made of mica and, under top plate 40, three bar heating chamber heaters 4 are provided so as to each extend rearward and in parallel each other. Among three heating chamber heaters 4, a peak value of a wavelength of infrared rays generated by one of heating chamber heaters 4, which is disposed at a center, is set shorter than other peak values of wavelengths of infrared rays generated by other two heating chamber heaters 4.

Wall surfaces of heating chamber 2 are each grounded with an earth cord (not shown). Rails 12 are integrally molded on left and right side walls of heating chamber 2. Rails 12 detachably retain a loading tray (not shown). Rails 12 are also grounded.

In this exemplary embodiment, the wall surfaces of heating chamber 2 are fluorine-coated for easy cleaning. However, the wall surfaces may be coated with enamel or another heat-resistance material. Stainless steel may be used as a material of the wall surfaces of heating chamber 2.

Behind heating chamber 2, a space partitioned from heating chamber 2 is provided. In this space, circulating fan 7 is provided for agitating and circulating air in heating chamber 2. In this space, convection heater 8, which is served as a chamber interior heater for heating air circulating in heating chamber 2, is provided to surround circulating fan 7.

Around a center of an inner wall in heating chamber 2, a plurality of air intake ventilation holes 16 for supplying air in heating chamber 2 to circulating fan 7, and, in contrast, a plurality of air blow ventilation holes 17 for supplying air from circulating fan 7 to heating chamber 2 are provided separately in different forming areas.

On the left side wall of heating chamber 2, intake holes 13 are provided. Through intake holes 13, air blown by a fan (not shown) is introduced to cool magnetrons 6a, 6b (microwave generators), control means 10, and the like. On a right portion of the inner wall of heating chamber 2, exhaust holes 29 are provided for exhausting air in heating chamber 2. Ventilation holes 13, 16, 17, 29 are formed with many punching holes.

At a top portion of the right side wall of heating chamber 2, infrared sensor 15 for detecting, through detection hole 27 provided on the right side wall of heating chamber 2, a temperature of a food product in heating chamber 2, and internal thermistor 9 for detecting, also through detection hole 27 provided on the right side wall of heating chamber 2, an ambient temperature in the heating chamber are provided.

At lower right outside heating chamber 2, magnetron 6a that is microwave generating means having an external dimension of approximately 90 mm×80 mm, when viewed from right, is provided in a horizontal direction (including approximately horizontal direction), and coupled to wave guide 14a. Wave guide 14a is configured in such a manner that an aluminum plated steel sheet is bent to entirely form an approximately L-shape served as an internal channel.

At around a center in a horizontal direction (including approximately horizontal direction) of heating chamber 2, rotating antenna 11a is provided. Rotating antenna 11a is made of an aluminum plated steel sheet, and coupled to motor 18a. Rotating antenna 11a agitates microwaves and applies microwaves into heating chamber 2. Similarly, at upper right outside heating chamber 2, magnetron 6b, rotating antenna 11b, wave guide 14b, and motor 18b are respectively provided in an approximately vertically inverted manner with respect to each of magnetron 6a, rotating antenna 11a, wave guide 14a, and motor 18a.

Although magnetrons 6a, 6b, rotating antennas 11a, 11b, wave guides 14a, 14b, and motors 18a, 18b are provided at lower and upper outside heating chamber 2, this configuration is merely an example. These components may be provided on a side face in desired installation directions.

Without providing rotating antennas 11a, 11b, microwaves may be supplied into heating chamber 2 only through outlets of wave guides 14a, 14b. In order to improve heating distribution, a turn table may further be provided for disposing and turning a food product.

On left of heating chamber 2, steam generator 20, water storage chamber 19 made of die-cast aluminum for storing water for generating steam, and water storage chamber cover 22 made of die-cast aluminum and provided to face an opening of water storage chamber 19 with a packing (not shown) interposed are provided. Around a center of water storage chamber 19 in a height direction, first steam generating heater 24 is molded in water storage chamber 19 made of die-cast aluminum in a horizontal direction (including approximately horizontal direction). This first steam generating heater 24 is a straight sheathed heater having an output of 650 W, and generates steam by heating water storage chamber 19.

Above first steam generating heater 24, second steam generating heater 25 is provided in a horizontal direction (including approximately horizontal direction). Second steam generating heater 25 is a straight sheathed heater having an output of 350 W, and generates steam by heating water storage chamber 19.

Steam guide channel 23 is made of a silicone tube having an inner diameter of φ10 mm, and provided above a ceiling surface of water storage chamber 19. Steam guide channel 23 supplies steam to a lower portion of a side face of heating chamber 2. At a tip of steam guide channel 23, steam ejection port 21 is provided to eject steam to the lower portion of the side face of heating chamber 2 in a horizontal direction (including approximately horizontal method).

Above second steam generating heater 25, water storage chamber thermistor 26 is provided. Water storage chamber thermistor 26 detects a temperature of water storage chamber 19. Below water storage chamber 19, water supply tank 50, water supply pump 51 for supplying water in water supply tank 50 to water storage chamber 19, and water supply channel 52 for guiding water supplied from water supply pump 51 to water storage chamber 19 are provided.

First steam generating heater 24 and second steam generating heater 25 are, in this exemplary embodiment, two different straight sheathed heaters having different outputs: 650 W for a lower heater, and 350 W for an upper heater, and a total output of 1000 W. However, this configuration is merely an example. In accordance with a shape and a required steam amount of water storage chamber 19, first steam generating heater 24 and second steam generating heater 25 may be configured by combining heaters so that a total output of other than 1000 W is achieved. Various combinations and the like may be applied, using heaters having identical outputs, a single heater or a minimum of three heaters, non-straight, U-shaped or L-shaped heaters, upper and lower heaters respectively having a higher output and a lower output.

Although steam guide channel 23 and steam ejection port 21 are formed in, in this exemplary embodiment, a circular cross-sectional shape, an oval shape or a rectangular shape may be applied. Although steam guide channel 23 and steam ejection port 21 are provided on, in this exemplary embodiment, the left side wall of heating chamber 2, steam guide channel 23 and steam ejection port 21 may be provided on a right or back side wall. A maximum inner size of a hole of steam ejection port 21 should advantageously be ½ of a wavelength of a microwave so that the microwave does not leak. Since, in this exemplary embodiment, a wavelength of a microwave is approximately 120 mm, an inner size of the hole of steam ejection port 21 should advantageously be a maximum of 60 mm.

In order to prevent scale components from adhering, an inner surface of water storage chamber 19 or an inner surface of water storage chamber cover 22 may be fluorine or silicone coated.

If water level detecting means is used, its sensitivity could lower due to adhered scale components, and, in a worst case, a water level could no longer be detected. However, by using temperature detecting means such as water storage chamber thermistor 26, improved reliability can be achieved against scale components. This is because, when temperature detecting means such as water storage chamber thermistor 26 is used, scale components can still adhere, but, even though scale components adhere, a temperature can still be detected.

Below heating chamber 2, control means is provided. In accordance with a cooking menu selected by a user, the control means controls magnetrons 6a, 6b, motors 18a, 18b, circulating fan 7, heaters, thermistors, infrared sensor 15, water supply pump 51, operation display 28, an internal light (not shown), and the like.

On tray table 3 positioned at the lower portion in heating chamber 2, loading table 30 is disposed so as to approximately wholly cover a bottom surface of heating chamber 2. Loading table 30 is provided away from heating chamber 2 to have a smaller gap (predetermined gap) so that loading table 30 is detachable from heating chamber 2. Although, in this exemplary embodiment, loading table 30 approximately wholly covers the bottom surface of heating chamber 2, loading table 30 may only partially cover the bottom surface. Although, in this exemplary embodiment, side walls of loading table 30 abut on tray table 3 to support loading table 30, this configuration is merely an example. Loading table 30 may be provided with leg shapes for supporting loading table 30 so that the side walls of loading table 30 are raised from tray table 3 or rails 12.

Provided under loading table 30 are, steam channel 32, and, to left of steam channel 32 and in a horizontal direction (including approximately horizontal direction) of steam channel 32, cylindrical steam introduction port 34.

An outer shape of steam ejection port 21 and an inner shape of steam introduction port 34 are approximately identical. Onto the outside of steam ejection port 21, steam introduction port 34 detachably fits in an overlapped manner with a length of approximately 30 mm. A lock mechanism may be provided to lock cylindrical-shaped steam ejection port 21 and steam introduction port 34 when fitting each other.

In contrast, an inner shape of steam ejection port 21 and an outer shape of steam introduction port 34 may be approximately identical so that, onto the inside of steam ejection port 21, steam introduction port 34 detachably fits in an overlapped manner.

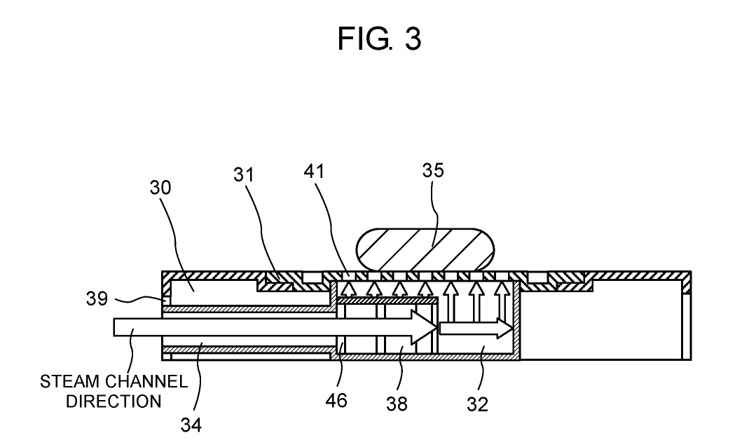

FIG. 3 is a front cross-sectional view of the loading table of the heat-cooking apparatus according to the first exemplary embodiment of the present invention.

In FIG. 3, loading table 30 has an approximately rectangular parallelepiped, box shape formed with a downward opening. A top surface of loading table 30 is formed in a plane (including approximately plane) in parallel (including approximately parallel) to tray table 3 at the lower portion of heating chamber 2, with a gap of approximately 40 mm from tray table 3.

Opening plate 31 fits to loading table 30 and steam channel 32, and is detachably attached at an approximately center portion of the top surface of loading table 30. At an approximately center portion of opening plate 31, a plurality of through holes, which is opening plate holes 41 (loading table opening portion) is formed. A top surface of opening plate 31 provided with opening plate holes 41 is formed approximately flush with the top surface of loading table 30. On opening plate 31, food product 35 is disposed.

Although, in this exemplary embodiment, a configuration is applied, where opening plate 31 and loading table 30 are separate components, a plurality of through holes may be provided on the top surface of loading table 30 without providing opening plate 31.

Steam channel 32 includes steam introduction port 34, and steam channel control plate 38 provided at a center portion of steam channel 32. Steam channel control plate 38 includes a plurality of steam channel control plate notches 46. Steam channel control plate 38 is detachably attached to steam channel 32 with tab configurations. Since, on both of the side walls of loading table 30, loading table notches 39 are provided so as not to interfere steam introduction port 34, even if loading table 30 is inserted in a wrong, left-right orientation, steam introduction port 34 and loading table 30 never come into contact with each other.

Steam introduction port 34, steam channel 32, steam channel control plate 38, opening plate 31, and loading table 30 are made of a microwave-transmittable, heat-resistant polypropylene resin having a heat-resisting temperature of 120° C. Although, in this exemplary embodiment, a heat-resistant polypropylene resin having a heat-resisting temperature of 120° C. is used, another material may be used.

Although steam ejection port 21 and steam introduction port 34 are provided in a horizontal direction (including approximately horizontal direction), steam ejection port 21 and steam introduction port 34 may be provided in an inclined direction or a vertical direction to fit each other.

Food product 35 includes, but not limited to, for example, refrigerated and frozen Chinese steamed buns, dumplings, rice products, and noodles, and the like. A quantity is not limited to one, but any quantity may be applied, as well as other heat-target objects than food products may be applied.

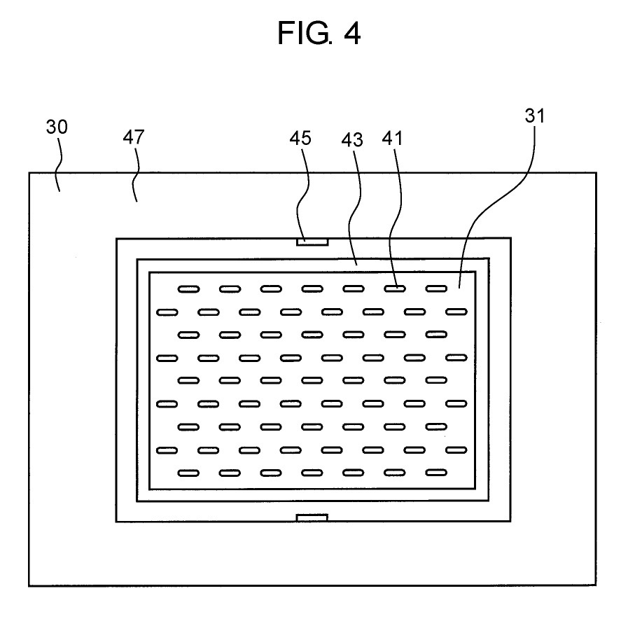

FIG. 4 is a top view of the loading table of the heat-cooking apparatus according to the first exemplary embodiment of the present invention, where no food product is disposed.

In FIG. 4, loading table 30 is provided with planar portion 47 around opening plate 31, where no hole is provided. Opening plate 31 has an approximately rectangular, thin-plate shape. A plurality of opening plate holes 41 is each formed in an oval track having longer sides in a longitudinal direction of loading table 30, and is disposed in a zigzag manner. A hole shape of each of opening plate holes 41 is not limited to an oval shape, but may be another shape including a circular shape and a rectangular shape, as long as the shape allows steam to pass through. However, since, depending on a size or shape of a hole, some types of food product 35 would be likely to pass through, a size or shape of each of opening plate holes 41 should be selected as required in accordance with food product 35.

On opening plate 31, two opening plate notches 45 are provided at a top and a bottom. Opening plate 31 is configured to easily be detachable to and from loading table 30 by inserting a finger or nail into each of opening plate notches 45. A tab configuration may be used to fit opening plate 31 and loading table 30 each other to prevent opening plate 31 from raising from loading table 30 due to pressure of steam.

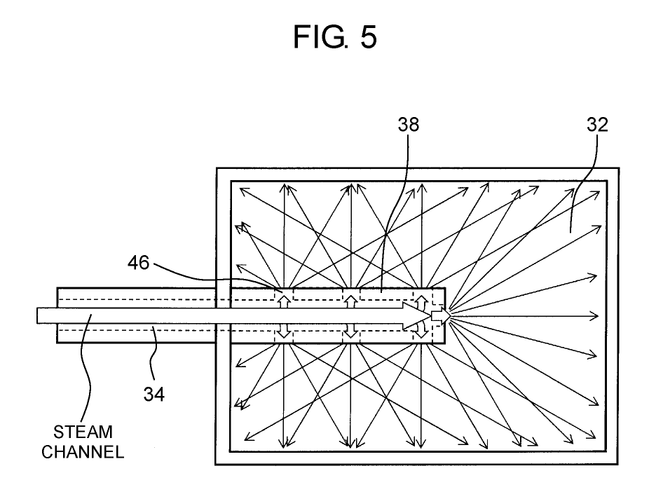

FIG. 5 is a top view of a steam channel of the heat-cooking apparatus according to the first exemplary embodiment of the present invention.

In FIG. 5, a total of seven steam channel control plate notches 46 is provided: six notches face in directions each perpendicular to a direction toward which the steam channel extends, and one notch faces in a direction identical to the direction toward which the steam channel extends and lies at around a center of the steam channel. A total area of one of steam channel control plate notches 46, which faces in a steam channel direction, is configured smaller than a total area of the other of steam channel control plate notches 46, which face in directions each perpendicular to the steam channel direction.

Steam channel control plate 38 guides steam flowed from steam introduction port 34 toward around a center of steam channel 32. Steam channel control plate notches 46 allow steam to easily flow in directions perpendicular and inclined to the steam channel direction to reduce unevenness in steam heating.

Sizes and a quantity of steam channel control plate notches 46 differ depending on a flow rate of steam, a size of steam channel 32, and other factors. When a flow rate of steam and/or a size of steam channel 32 is smaller, either or both of steam channel control notches 46 and steam channel control plate 38 may not be provided, as long as steam can evenly expand in steam channel 32.

An operation and an effect of the heat-cooking apparatus configured as described above will be described below.

First, a user of high frequency heat-cooking apparatus 1 opens door 5, and sets, by fitting steam introduction port 34 of steam channel 32 and steam ejection port 21 of heating chamber 2 each other, steam channel 32 on tray table 3. Next, the user disposes loading table 30 on tray table 3 so that planar portion 47 of loading table 30 covers steam channel 32. The user then sets opening plate 31 so as to cover the opening portion of loading table 30.

The above described operation is not always required, but may be performed as required when some components are removed for cleaning, for example.

To steam heat food product 35, the user disposes food product 35 on opening plate 31 of loading table 30. In a normal operation when loading table 30 and the like have been set, the user of high frequency heat-cooking apparatus 1 is required to perform the above described operation only. The user then closes door 5, and selects a steam menu on operation display 28 to start heating.

Upon the heating starts, first steam generating heater 24 and second steam generating heater 25 are powered on and heated to heat water storage chamber 19. After that, upon water storage chamber thermistor 26 detects a temperature of water storage chamber 19 exceeding a predetermined temperature, water supply pump 51 supplies water in water supply tank 50, through water supply channel 52, to water storage chamber 19. Steam then instantaneously comes out. Water may be stored and heated in water storage chamber 19 so that steam gradually comes out.

The generated steam comes out of water storage chamber 19, passes through steam guide channel 23, and is ejected from steam ejection port 21. The steam ejected from steam ejection port 21 passes through steam introduction port 34, and flows into steam channel 32. The steam then passes through steam channel control plate notches 46 of steam channel control plate 38 in a branched manner and is guided toward the center portion of steam channel 32. The steam guided to the center portion of steam channel 32 passes through a channel narrowed by steam channel control plate 38, branches in three directions in the branched channel, expands into steam channel 32, and fully fills in steam channel 32.

After that, the steam is ejected from opening plate holes 41 into around food product 35 in heating chamber 2, condenses around whole food product 35, and gives latent heat of vaporization to and evenly heats food product 35. In particular, in a case when food product 35 includes many gaps or is a porous material (for example, noodles), steam can easily enter into and effectively heat from inside of food product 35. After heated, the user of high frequency heat-cooking apparatus 1 opens door 5, and takes out food product 35, and then the user is able to readily serve the food product to a consumer, in a scene when the heat-cooking apparatus is used in a store, for example.

After that, to microwave heat food product 35 without using steam, the user is able to heat food product 35 by simply disposing food product 35 on loading table 30 including opening plate 31.

An operation of microwave heating will be described below.

A user of high frequency heat-cooking apparatus 1 selects a microwave menu on operation display 28 to start heating. Microwaves radiated from magnetrons 6a, 6b and transmitted into wave guides 14a, 14b are then supplied to rotating antennas 11a, 11b rotated by motors 18a, 18b. The microwaves passed through rotating antennas 11a, 11b are agitated and applied downward and upward into heating chamber 2.

Most of the microwaves is directly absorbed by food product 35 for heating. In particular, microwaves radiated upward tend to easily hit and heat a lower portion of food product 35, while microwaves radiated downward tend to easily hit and heat a top portion of food product 35. By controlling respective outputs of microwaves to be radiated downward and upward, as well as controlling rotations of rotating antennas 11a, 11b, distribution of microwaves in heating chamber 2 can be altered to select an appropriate distribution capability in conformity to a type, a shape, a position, a quantity, and the like of food product 35.

Although, in this exemplary embodiment, individual steam heating and individual microwave heating are exemplified, complex heating of microwaves and steam may be performed, as well as individual heating and complex heating with radiant heat and hot blast using heating chamber heaters 4 and convection heater 8 may be performed.

As described above, the heat-cooking apparatus according to this exemplary embodiment includes heating chamber 2 for heating food product 35, steam generator 20 for generating steam, and steam channel 32 provided in heating chamber 2 for guiding steam generated by steam generator 20. The heat-cooking apparatus further includes loading table 30 for disposing food product 35, which is raised from the bottom surface of heating chamber 2 to create a predetermined gap, and opening plate 31 fitting to loading table 30. On opening plate 31, opening plate holes 41 for guiding steam from steam channel 32 to food product 35 are provided. Steam generated by steam generator 20 passes through steam channel 32 and opening plate holes 41 to heat food product 35.

Therefore, by simply disposing food product 35 on opening plate 31 of loading table 30, and performing steam heating, steam cooking can easily be performed without using a steamer. Steam channel 32 guides steam to opening plate 31 of loading table 30 without allowing steam to disperse in heating chamber 2. The steam is then directly ejected around food product 35. Therefore, food product 35 can effectively be heated, and unevenness in heating around steam ejection port 21 and dew condensation on the internal walls of heating chamber 2 can be reduced to minimum.

Since moisture, oil components, and the like generated from food product 35 drop onto steam channel 32, heating chamber 2 can be kept clean. Therefore, maintenance can easily be performed by cleaning steam channel 32 only.

The top surface of loading table 30 may be a plane (including approximately plane).

Therefore, even a flat, larger food product 35 can easily be disposed and heated on loading table 30, without leaving food product 35 inclined.

Loading table 30 and opening plate 31 having opening plate holes 41 may be provided separately, and opening plate 31 may be detachably provided to loading table 30.

Therefore, by removing opening plate 31 only from loading table 30, moisture, oil components, and the like generated from food product 35 and adhered onto opening plate 31 can easily be cleaned. By removing opening plate 31, steam channel 32 that would also be contaminated as described above can easily be cleaned from above.

Loading table 30 may be detachably provided to heating chamber 2.

Therefore, by removing loading table 30 from heating chamber 2, moisture, oil components, and the like generated from food product 35 and adhered onto loading table 30 can easily be cleaned. Since, by removing loading table 30, an area occupied by loading table 30 becomes available, further taller food product 35 can be disposed and heated in heating chamber 2.

Steam generator 20 may further include steam ejection port 21 for ejecting generated steam, and steam introduction port 34 for guiding the steam to steam channel 32, where steam ejection port 21 and steam introduction port 34 are detachable each other.

By removing steam channel 32 from steam ejection port 21, moisture, oil components, and the like generated from food product 35 and adhered onto steam channel 32 can easily be cleaned.

Magnetrons 6a, 6b may be provided so that microwaves generated from magnetrons 6a, 6b are used to heat food product 35.

When steam heating and microwave heating are simultaneously performed, through defrosting of a surface of food product 35 with steam, a rate of absorption of microwave can be increased, and food product 35 can effectively be heated. In particular, this method is effective when food product 35 is a frozen food product with a lower rate of absorption of microwaves.

An outer shape of steam ejection port 21 and an inner shape of steam introduction port 34 may be fitted each other in an overlapped manner.

Therefore, steam can securely be prevented from leaking from a gap between steam ejection port 21 and steam introduction port 34 into heating chamber 2. By simply fitting and inserting steam introduction port 34 into steam ejection port 21, the user of heat-cooking apparatus can easily perform positioning of steam channel 32.

Steam channel control plate 38 may further be provided in steam channel 32 for altering a steam channel direction.

Therefore, steam can evenly fill in steam channel 32 to reduce unevenness in heating of food product 35.

Steam channel control plate 38 may be configured to narrow or bend a steam channel from the steam channel direction.

If steam channel control plate 38 is not provided, steam flows only in a travel direction, and food product 35 is only partially heated. However, when steam channel control plate 38 is provided, food product 35 can therefore be prevented from being only partially heated, and unevenness in heating of food product 35 can be reduced.

Steam channel control plate 38 may be detachable from steam channel 32.

Therefore, moisture, oil components, and the like generated from food product 35 and adhered onto steam channel control plate 38 and steam channel 32 can easily be cleaned.

When performing heating with heating means other than steam, since food product 35 can be disposed at any position of loading table 30, food product 35 can easily be heated.

Although, in this exemplary embodiment, high frequency heat-cooking apparatus 1 that generates microwaves is used, a heat-cooking apparatus including at least steam generator 20 can obtain similar or identical effects.

### SECOND EXEMPLARY EMBODIMENT

Next, a second exemplary embodiment of the present invention will be described. Configurations and operations different from configurations and operations of the first exemplary embodiment will mainly be described below, where components identical to the components of the first exemplary embodiment are denoted by identical numbers or symbols, and detailed descriptions of the configurations and operations are omitted.

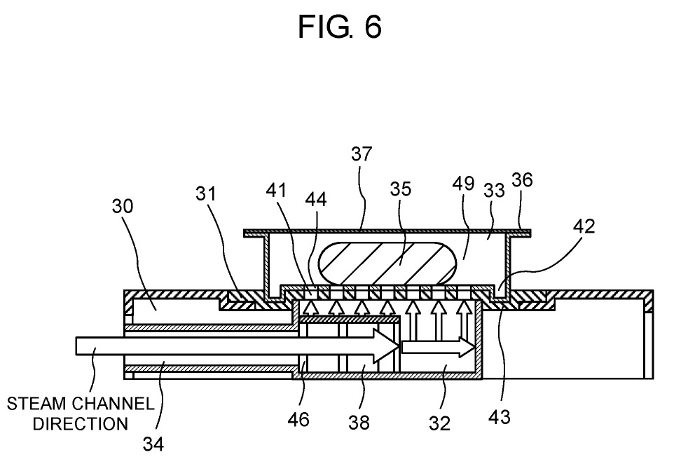

FIG. 6 is a front cross-sectional view of a loading table of a heat-cooking apparatus according to the second exemplary embodiment of the present invention.

In FIG. 6, food container 33 having a rectangular parallelepiped shape is provided on opening plate 31. Food container 33 accommodates food product 35 that is a heat-target object. A top opening portion of food container 33 is covered with cover 36 having a plurality of through holes that is steam holes 37. Protrusion 42 of food container 33 is configured to fit to recess 43 of opening plate 31 so that steam is less likely to leak outside. With food container holes 44 formed on a bottom portion of food container 33 and opening plate holes 41, both of which are a plurality of through holes, steam channel 32 and food container 33 are in communication with each other.

An outer shell shape of food container 33 may be, in addition to the rectangular parallelepiped shape, but not limited to, a column shape, as long as food product 35 can be accommodated.

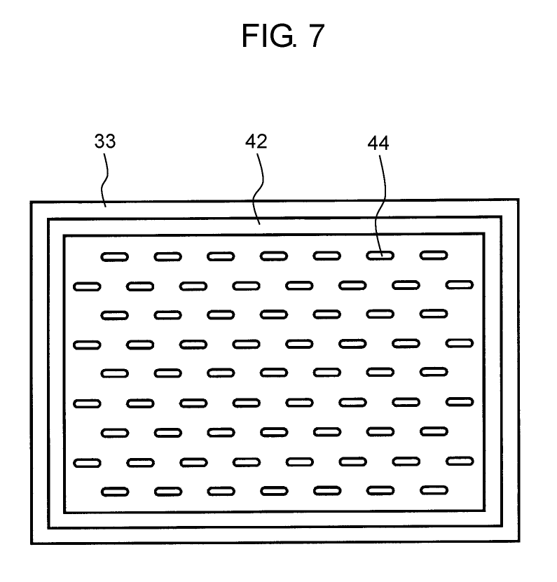

FIG. 7 is a top view of the food container of the heat-cooking apparatus according to the second exemplary embodiment of the present invention, where a cover is removed.

In FIG. 7, food container holes 44 of food container 33 are each formed at a position and in a size approximately identical to a position and a size of each of opening plate holes 41. Through fitting of protrusion 42 of food container 33 and recess 43 of opening plate 31, food container holes 44 and opening plate holes 41 easily coincide with each other.

An operation and an effect of the heat-cooking apparatus according to this exemplary embodiment configured as described above will be described below.

First, a user of high frequency heat-cooking apparatus 1 opens door 5, and sets, by fitting steam introduction port 34 of steam channel 32 and steam ejection port 21 of heating chamber 2 each other, steam channel 32 on tray table 3. Next, the user disposes loading table 30 on tray table 3 so that planar portion 47 of loading table 30 covers steam channel 32. The user then sets opening plate 31 so as to cover the opening portion of loading table 30.

The above described operation is not always required, but may be performed as required when some components are removed for cleaning, for example.

To perform steam heating, the user fits protrusion 42 of food container 33 accommodated with food product 35 with recess 43 of opening plate 31, and then sets food container 33 to opening plate 31. Opening plate holes 41 and food container holes 44 then become automatically in communication with each other. In a normal operation when loading table 30 and the like have been set, the user is required to perform the above described operation only. The user then closes door 5, and selects a steam menu on operation display 28 to start heating.

Upon the heating starts, first steam generating heater 24 and second steam generating heater 25 are powered on and heated to heat water storage chamber 19. After that, upon water storage chamber thermistor 26 detects a temperature of water storage chamber 19 exceeding a predetermined temperature, water supply pump 51 supplies water in water supply tank 50, through water supply channel 52, to water storage chamber 19. Steam then instantaneously comes out. Water may be stored and heated in water storage chamber 19 so that steam gradually comes out.

The generated steam comes out of water storage chamber 19, passes through steam guide channel 23, and is ejected from steam ejection port 21. The steam ejected from steam ejection port 21 passes through steam introduction port 34, and flows into steam channel 32. The steam then passes through steam channel control plate notches 46 of steam channel control plate 38 in a branched manner and is guided toward the center portion of steam channel 32. The steam guided to the center portion of steam channel 32 passes through a channel narrowed by steam channel control plate 38, branches in three directions in the branched channel, expands into steam channel 32, and fully fills in steam channel 32.

After that, the steam passes through opening plate holes 41 and food container holes 44, condenses around, gives latent heat of vaporization to, and evenly heats whole food product 35. In particular, in a case when food product 35 includes many gaps or is a porous material (for example, noodles), steam can easily enter into and effectively heat from inside of food product 35. When steam fills in food container 33, an effect can be expected, where a dielectric constant in a space alters, a wavelength of microwaves in food product disposing chamber 49 shortens, and unevenness in heating reduces.

When heating advances, and a temperature of food product 35 rises, steam will be less likely to condense on food product 35, but will fill as is in food container 33. The non-condensed, filled steam is finally discharged from steam holes 37 of cover 36 to outside of food container 33.

After heated, the user of high frequency heat-cooking apparatus 1 opens door 5, and lifts and takes out food container 33 from opening plate 31, and then the user is able to readily serve food product 35 to a consumer, in a scene when the heat-cooking apparatus is used in a store, for example.

After that, to microwave heat food container 33 or food product 35 without using steam, the user is able to heat food container 33 or food product 35 by simply disposing food container 33 or food product 35 on loading table 30 including opening plate 31.

As described above, the heat-cooking apparatus according to this exemplary embodiment further includes, on opening plate 31, food container 33 for accommodating food product 35, where food container holes 44 of food container 33 and opening plate holes 41 coincide with each other so that steam channel 32 and food container 33 are in communication with each other.

Therefore, steam can fill, without being dispersed in heating chamber 2, only in a narrower space of food container 33 to further effectively heat food product 35. Therefore, a heating time can be reduced, and food product 35 can be well cooked in an improved manner.

Since most of moisture, oil components, and the like generated from food product 35 can be stored in food container 33, heating chamber 2, loading table 30, opening plate 31, and steam channel 32 can be prevented from being contaminated for improved ease of cleaning. Since a user does not have to directly touch food product 35, the user is free from burns, and is able to handle food product 35 in a sanitary manner.

When steam heating and microwave heating are simultaneously performed, and steam fills in food container 33, an effect can be expected, where a dielectric constant in a space alters, a wavelength of microwaves in food product disposing chamber 49 shortens, and unevenness in heating reduces. In particular, when food product 35 is a frozen food product, even its rate of absorption of microwaves is lower, a surface of food product 35 can be defrosted with steam, a rate of absorption of microwaves can be increased, and food product 35 can effectively be heated.

A heating element for absorbing microwaves for heating may further be provided to food container 33.

Therefore, food product 35 can be heated not only with steam and microwaves, but also through thermal conduction from the heating element.

A plurality of food products 35 may be disposed in food container 33 for simultaneous heating to promptly heat the plurality of food products.

Although, in this exemplary embodiment, protrusion 42 of food container 33 and recess 43 of opening plate 31 are fitted each other, another fitting shape may be applied. Various forms may be applied for fitting, for example, food container 33 is rib-formed so as to fit to recess 43 of opening plate 31. Even if no fitting shape is applied, for example, opening plate holes 41 may be meshed with a plurality of small holes so that, even if food container 33 is disposed in a slightly-misaligned manner, steam can flow from opening plate holes 41 into food container holes 44. In short, any configuration may be applied, as long as steam is guided into food container holes 44.

In this exemplary embodiment, by providing steam holes 37 on cover 36, a small amount of steam can come out of steam holes 37 to create a flow of steam in food container 33 for steam-heating food product 35 in an improved manner. However, this configuration is merely an example, and a configuration may be applied, where steam holes 37 are eliminated and, when a large amount of steam fills in food container 33, a small amount of steam can come out of a gap between food container 33 and cover 36.

In addition to the first exemplary embodiment and the second exemplary embodiment, a combination of the first exemplary embodiment and the second exemplary embodiment also falls within the scope of the present invention.

### INDUSTRIAL APPLICABILITY

As described above, the heat-cooking apparatus according to the present invention is applicable to microwave ovens, steamers and other similar apparatuses that include a steam generator.

### REFERENCE MARKS IN THE DRAWINGS

1 high frequency heat-cooking apparatus (heat-cooking apparatus)

2 heating chamber

3 tray table

4 heating chamber heater

5 door

6a, 6b magnetron (microwave generator)

20 steam generator

21 steam ejection port

30 loading table

31 opening plate

32 steam channel

33 food container

34 steam introduction port

35 food product

36 cover

37 steam hole

38 steam channel control plate

41 opening plate hole (loading table opening portion)

42 protrusion

43 recess

44 food container hole (loading table opening portion)

49 food product disposing chamber

1. A heat-cooking apparatus comprising:
a heating chamber for heating a food product;
a steam generator for generating steam;
a steam channel provided in the heating chamber for guiding steam generated by the steam generator;
a loading table for disposing a heat-target object, the loading table being raised from a bottom surface of the heating chamber to create a predetermined gap; and
a loading table opening portion provided on the loading table for guiding the steam from the steam channel to the heat-target object,
wherein the steam generated by the steam generator passes through the steam channel and the loading table opening portion to heat the heat-target object.

2. The heat-cooking apparatus according to claim 1, wherein a top surface of the loading table is formed in a plane.

3. The heat-cooking apparatus according to claim 1, wherein the loading table and an opening plate having the loading table opening portion are provided separately, the opening plate being detachably provided to the loading table.

4. The heat-cooking apparatus according to claim 1, wherein the loading table is detachably provided to the heating chamber.

5. The heat-cooking apparatus according to claim 1, wherein the steam generator includes a steam ejection port for ejecting generated steam, the steam ejection port being detachable from the steam channel each other.

6. The heat-cooking apparatus according to claim 1, comprising a steam channel control plate for altering a steam channel direction in the steam channel.

7. The heat-cooking apparatus according to claim 1, further comprising, on the loading table, a food container for accommodating a heat-target object, the food container having a bottom surface provided with a food container hole that is in communication with the loading table opening portion.

8. The heat-cooking apparatus according to claim 7, wherein the food container includes a cover provided with a steam hole.

9. The heat-cooking apparatus according to claim 1, further comprising a microwave generator,
wherein the microwave generator generates microwaves to heat the heat-target object.
